(19) United States
(12) Patent Application Publication
(10) Pub. No.: US 2026/0138613 A1
(43) Pub. Date: May 21, 2026

(54) METHOD AND CONTROLLER FOR CONTROLLING VEHICLE

(71) Applicant: ABB SCHWEIZ AG, Baden (CH)

(72) Inventors: Dong Wu, Shanghai (CN); Yaodong Ni, Shanghai (CN); Xuan Cao, Shanghai (CN)

(21) Appl. No.: 19/442,252

(22) Filed: Jan. 7, 2026

Related U.S. Application Data
(63) Continuation of application No. PCT/CN2023/108159, filed on Jul. 19, 2023.

(51) Int. Cl. B60W 30/182; G05D 1/244; G05D 1/246; G05D 111/10

(52) U.S. Cl. CPC B60W 30/182; G05D 1/244; G05D 1/246; G05D 2111/17

(57) ABSTRACT

A method includes determining, based on preset information associated with a target path, a navigation mode of the vehicle from a navigation mode group comprising a magnetic navigation mode and a simultaneous localization and mapping, SLAM, navigation mode; determining, based on sensing information from a sensing device corresponding to the determined navigation mode, a deviation between a location of the vehicle and the target path; and controlling movement of the vehicle based on the determined deviation.

### FIELD

Embodiments of present disclosure generally relate to vehicle navigation technology, and more particularly, to a method and controller for controlling a vehicle and a vehicle comprising the controller.

### BACKGROUND

In the industrial field, vehicles such as automatic guided vehicles (AGVs) are widely utilized for reducing labor cost and improving production automation. Generally, the AGVs can be automatically driven along a preset route by means of a navigation. At present, the navigation means adopted by the AGVs include magnetic navigation and simultaneous localization and mapping (SLAM) navigation.

There are disadvantages in the existing navigation means. For example, for the magnetic navigation manner, the magnetic tape as the routing line is required, but it is easy to be damaged. Due to the fixed running line, it is troublesome to change and expand the line. Although the SLAM navigation needs no magnetic tape and can navigate, plan, change and expand the line more flexibly, its navigation is less accurate than the magnetic navigation.

### SUMMARY

Embodiments of the present disclosure provide a method and controller for controlling a vehicle and a vehicle comprising the controller.

In a first aspect, a method for controlling a vehicle is provided. The method comprises: determining, based on preset information associated with a target path, a navigation mode of the vehicle from a navigation mode group comprising a magnetic navigation mode and a simultaneous localization and mapping, SLAM, navigation mode; determining, based on sensing information from a sensing device corresponding to the determined navigation mode, a deviation between a location of the vehicle and the target path; and controlling movement of the vehicle based on the determined deviation.

In some embodiments, the target path comprises a plurality of nodes and at least one edge between nodes.

In some embodiments, the preset information comprises a preset type of the respective node, and determining, based on the preset information associated with the target path, the navigation mode of the vehicle from the navigation mode group comprises: identifying a latest node reached by the vehicle in the plurality of nodes; and determining, based on the preset type of the identified latest node, the navigation mode of the vehicle.

In some embodiments, determining, based on the sensing information from the sensing device corresponding to the determined navigation mode, the deviation between the location of the vehicle and the target path comprises: determining, based on the sensing information, displacement and angle differences between the location of the vehicle and the target path; and determining, based on the displacement and angle differences, the deviation between the location of the vehicle and the target path.

In some embodiments, determining, based on the displacement and angle differences, the deviation between the location of the vehicle and the target path comprises: calculating the deviation by adding a product of the displacement difference and a first constant to a product of the angle difference and a second constant.

In some embodiments, the sensing device corresponding to the SLAM navigation comprises at least one of a laser radar and a vision sensor, and determining, based on the sensing information, the displacement and angle differences between the location of the vehicle and the target path comprises: if the navigation mode of the vehicle is the SLAM navigation mode, receiving first sensing information from the at least one of the laser radar and the vision sensor, the first sensing information indicating a position and orientation of the vehicle; and calculating, based on the first sensing information, the displacement and angle differences between the location of the vehicle and the target path.

In some embodiments, the preset information comprises a coordinate of the respective node in a reference frame, and calculating, based on the first sensing information, the displacement and angle differences between the location of the vehicle and the target path comprises: determining, based on the first sensing information, a coordinate and orientation angle of the vehicle in the reference frame; identifying a latest node reached by the vehicle and a next node in the target path; calculating, based on the coordinate and orientation angle of the vehicle and the coordinates of the identified latest and next nodes, the displacement and angle differences between the location of the vehicle and the target path.

In some embodiments, calculating, based on the coordinate and orientation angle of the vehicle and the coordinates of the identified latest and next nodes, the displacement and angle differences between the location of the vehicle and the target path comprises: determining, based on the coordinate of the vehicle and the coordinates of the identified latest and next nodes, whether the vehicle lies on the left side or right side of an edge between the identified latest and next nodes, which indicates a sign of the displacement difference; calculating, based on the coordinate of the vehicle and the coordinates of the identified latest and next nodes, a magnitude of the displacement difference; and calculating the angle difference based on the orientation angle of the vehicle and the coordinates of the identified latest and next nodes.

In some embodiments, the sensing device corresponding to the magnetic navigation mode comprises a plurality of magnetic stripe sensors, and determining, based on the sensing information, the displacement and angle differences between the location of the vehicle and the target path comprises: if the navigation mode of the vehicle is the magnetic navigation mode, receiving second sensing information from the plurality of magnetic stripe sensors, the second sensing information indicating positions of the plurality of magnetic stripe sensors relative to a magnetic tape; and calculating, based on the second sensing information, the displacement and angle differences between the location of the vehicle and the target path.

In some embodiments, the plurality of magnetic stripe sensors comprise a first magnetic stripe sensor arranged at the front of the vehicle and a second magnetic stripe sensor arranged at the back of the vehicle, and calculating, based on the second sensing information, the displacement and angle differences between the location of the vehicle and the target path comprises: determining, based on the second sensing information, a first offset of the center of the first magnetic stripe sensor from the magnetic tape and a second offset of the center of the second magnetic stripe sensor from the magnetic tape; and calculating the displacement and angle differences based on the first and second offsets and a distance between the centers of the first and second magnetic stripe sensors.

In some embodiments, controlling the movement of the vehicle based on the determined deviation comprises: determining a difference between the determined deviation and a reference deviation; and controlling the movement of the vehicle based on the determined difference.

In some embodiments, the preset information comprises a coordinate of the respective node in a reference frame, the method further comprising: if the navigation mode of the vehicle is the SLAM navigation mode, determining, based on the sensing information, a coordinate of the vehicle in the reference frame; calculating, based on the coordinates of the vehicle and the next node in the reference frame, a distance between the vehicle and the next node; and in response the distance less than a threshold, determining that the vehicle reaches the next node.

In some embodiments, the method further comprising: if the navigation mode of the vehicle is the magnetic navigation mode, receiving a detection signal from a RFID sensor; and in response to the detection signal identifying a next node in the target path, determining that the vehicle reaches the next node.

In a second aspect, a controller for controlling a vehicle is provided. The controller comprises: at least one processing unit; and at least one memory coupled to the at least one processing unit and storing instructions executable by the at least one processing unit, the instructions, when executed by the at least one processing unit, causing the device to perform the method according to the first aspect.

In a third aspect, a computer readable storage medium is provided. The computer readable storage medium has computer readable program instructions stored thereon which, when executed by a processing unit, cause the processing unit to perform the method according to the first aspect.

In a fourth aspect, a vehicle is provided. The vehicle comprises: sensing devices; and the controller according to the second aspect.

In some embodiments, the sensing devices comprises a plurality of magnetic stripe sensors and at least one of a laser radar and a vision sensor.

### DESCRIPTION OF DRAWINGS

Drawings described herein are provided to further explain the present disclosure and constitute a part of the present disclosure. The example embodiments of the disclosure and the explanation thereof are used to explain the present disclosure, rather than to limit the present disclosure improperly.

FIG. 1 illustrates a schematic diagram of a working site for a vehicle in accordance with an embodiment of the present disclosure.

FIG. 2 illustrates a schematic diagram of the vehicle in accordance with an embodiment of the present disclosure.

FIG. 3 illustrates a flowchart of a method for controlling the vehicle in accordance with an embodiment of the present disclosure.

FIGS. 4, 5 and 6 illustrate schematic diagrams of a human-machine interface for the target path of the vehicle in accordance with an embodiment of the present disclosure.

FIG. 7 illustrates a schematic diagram of the position relationship between the vehicle and a section of the target path in the SLAM navigation in accordance to an embodiment of the present disclosure.

FIG. 8 illustrates a schematic diagram of the displacement difference between the vehicle and the target path in accordance to an embodiment of the present disclosure.

FIG. 9 illustrates a schematic diagram of the displacement difference between the vehicle and the target path in accordance to an embodiment of the present disclosure.

FIG. 10 illustrates a schematic diagram of the position relationship between the vehicle and a section of the target path in the magnetic navigation in accordance to an embodiment of the present disclosure.

FIG. 11 illustrates a schematic block diagram of the sensing devices, the controller and the driving assembly in accordance with an embodiment of the present disclosure.

FIG. 12 illustrates a flowchart of procedure of determining the navigation mode of the vehicle in accordance with an embodiment of the present disclosure.

FIG. 13 illustrates a flowchart of procedure of determining the deviation between the location of the vehicle and the target path in accordance with an embodiment of the present disclosure.

FIG. 14 illustrates a flowchart of procedure of determining the displacement and angle differences in the SLAM navigation mode in accordance with an embodiment of the present disclosure.

FIG. 15 illustrates a flowchart of procedure of calculating the displacement and angle differences based on the first sensing information in accordance with an embodiment of the present disclosure.

FIG. 16 illustrates a flowchart of procedure of determining the displacement and angle differences in the magnetic navigation in accordance with an embodiment of the present disclosure.

FIG. 17 illustrates a flowchart of procedure of calculating the displacement and angle differences based on the second sensing information in accordance with an embodiment of the present disclosure.

FIG. 18 illustrates a flowchart of procedure of controlling the movement of the vehicle based on the determined deviation in accordance with an embodiment of the present disclosure.

FIG. 19 illustrates a schematic block diagram of an example device adapted to implement embodiments of the present disclosure.

Throughout the drawings, the same or similar reference symbols are used to indicate the same or similar elements.

### DETAILED DESCRIPTION OF EMBODIMENTS

Principles of the present disclosure will now be described with reference to several example embodiments shown in the drawings. Though example embodiments of the present disclosure are illustrated in the drawings, it is to be understood that the embodiments are described only to facilitate those skilled in the art in better understanding and thereby achieving the present disclosure, rather than to limit the scope of the disclosure in any manner.

The term “comprises” or “includes” and its variants are to be read as open terms that mean “includes, but is not limited to.” The term “or” is to be read as “and/or” unless the context clearly indicates otherwise. The term “based on” is to be read as “based at least in part on.” The term “being operable to” is to mean a function, an action, a motion or a state can be achieved by an operation induced by a user or an external mechanism. The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below. A definition of a term is consistent throughout the description unless the context clearly indicates otherwise.

Unless specified or limited otherwise, the terms “mounted,” “connected,” “supported,” and “coupled” and variations thereof are used broadly and encompass direct and indirect mountings, connections, supports, and couplings. Furthermore, “connected” and “coupled” are not restricted to physical or mechanical connections or couplings. In the description below, like reference numerals and labels are used to describe the same, similar or corresponding parts in the figures. Other definitions, explicit and implicit, may be included below.

As discussed above, conventional navigation approaches for the vehicles may have several disadvantages. The conventional AGVs in the factories adopt only one of the magnetic navigation and the SLAM navigation. For using the mere magnetic navigation, the change of the running line requires a lot of efforts and material resources to redesign and lay magnetic tapes, which is not beautiful, flexible and convenient, and sometimes AGV will run too fast to read the RFID tags. For using the mere SLAM navigation, because the navigation accuracy is greatly affected by the environment and limited by the algorithm itself, accuracy requirement often cannot be met in some occasions where accurate positioning is required. Some solutions attempt to simply combine both of the magnetic and SLAM navigations into one AGV, but this renders a significant increase in cost and complexity which is not acceptable.

According to embodiments of the present disclosure, an improved navigation solution for a vehicle is proposed. In the improved solution, the navigation mode of the vehicle in the different sections of the routing line can be defined in the preset information for the target path. In this way, the vehicle can selectively select the SLAM navigation in some sections of the routing line and select the magnetic navigation in some other sections, or use one of the magnetic and SLAM navigations entirely. Thus, the vehicle can use the magnetic navigation in areas with high accuracy requirements, and can use the SLAM navigation in area with low accuracy requirements. Thereby, some layouts for the magnetic tape and RFID tag are saved, and the running line can be changed more conveniently and flexibly, while the high positioning accuracy is still ensured. Moreover, compared with the existing solution of simply combining two types of navigations, the improved solution can integrate both of the magnetic and SLAM navigations in a vehicle with the lower cost and efforts. The navigation of SLAM can be easily added into the AGV with magnetic stripe navigation. That is, the existing AGV with magnetic navigation can easily change to be compatible with laser SLAM navigation or directly upgrade to SLAM navigation mode.

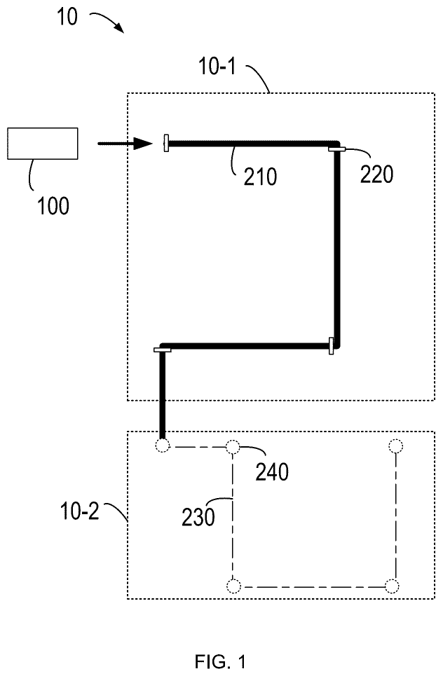

FIG. 1 illustrates a schematic diagram of a working site 10 in accordance with an embodiment of the present disclosure. As an example, the working site 10 may be a factory for logistics or automated manufacturing, and comprises a first area 10-1 with a magnetic tape 210 and a second area 10-2 without magnetic tapes. A vehicle 100 including, but not limited to, an AGV and any other automatic vehicle may move or run in the areas 10-1 and 10-2 for loading, transporting and unloading parts or goods, or for performing any suitable actions. By means of a magnetic navigation, the vehicle 100 runs along the magnetic tape 210 in the area 10-1. Furthermore, one or more tags 220 are fixed in certain points of the magnetic tape 210, so that the vehicle 100 performs certain actions (e.g., a stop action, an acceleration, a deceleration and other actions) at these points with the tags. By means of a SLAM navigation, the vehicle 100 runs along a virtual predefined line 230 in the area 10-2, and can perform certain actions at these virtual points 240. It is appreciated that the vehicle 100 can also run in the area 10-1 by the SLAM navigation, and the route of the vehicle 100 in the working site 10 can be changed according to actual requirements. Furthermore, the working site 10 may comprise more areas with or without the magnetic tape and may comprise more vehicles, and the embodiments of the present disclosure do not impose any limitation on the number of the areas and the vehicles.

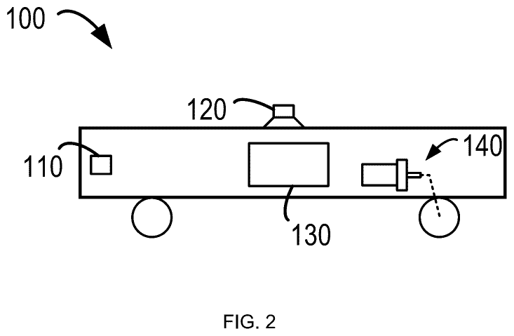

FIG. 2 illustrates a schematic diagram of the vehicle 100 in accordance with an embodiment of the present disclosure. As shown in FIG. 2, the vehicle 100 comprises sensing devices 110 and 120. The sensing devices 110 and 120 are used in the magnetic and SLAM navigations respectively. In some embodiments, the sensing device 110 comprise a plurality of magnetic stripe sensors. The plurality of magnetic stripe sensors can sense and determine the position of the magnetic tape in the magnetic navigation, thereby ensuring the vehicle 100 to accurately move along the magnetic tape 210. In some embodiments, the sensing device 120 comprises at least one of a laser radar and a vision sensor. The laser radar and the vision sensor can detect the position of the vehicle 100 by means of laser ranging and image recognition respectively, thereby ensuring the vehicle 100 to move along a desired route without the magnetic tape.

The vehicle 100 further comprises a controller 130 and a driving assembly 140. As an example, the controller 130 includes any type of control devices capable of performing calculations and processing, e.g., MCU, DSP and FPGA, or can be realized by digital circuits and/or analog circuits, or a combination of multiple forms. It is appreciated that the controller 130 may be a single control device or a combination of multiple control devices, and in the case of multiple control devices, the multiple control devices may be located at a same location or different locations in the vehicle 100. For example, one or more control device of the multiple control devices may be integrated with the sensing device(s) 110 and/or 120, e.g., the one or more control device may be a SLAM controller integrated with the laser radar or the vision sensor, and thus can obtain a deviation of the vehicle from a target path during the SLAM navigation and provide the deviation to the main control device or another control device. Moreover, as an example, the driving assembly 140 comprises a plurality of wheels, at least one motor and a driver, and the driver may comprise power electronics and circuits for controlling and driving the at least one motor and the plurality of wheels. The controller 130 can communicate with the sensor devices 110 and 120 and the driving assembly 140 in a wireless or wire manner, in order to obtain the sensing information from the sensing devices 110 and 120 and control the driving assembly 140. Moreover, the controller 130 can remotely communicate with a control center or a remote control unit located away from the vehicle 100, thereby receiving command therefrom and/or sending the state parameters of the vehicle 100 to there.

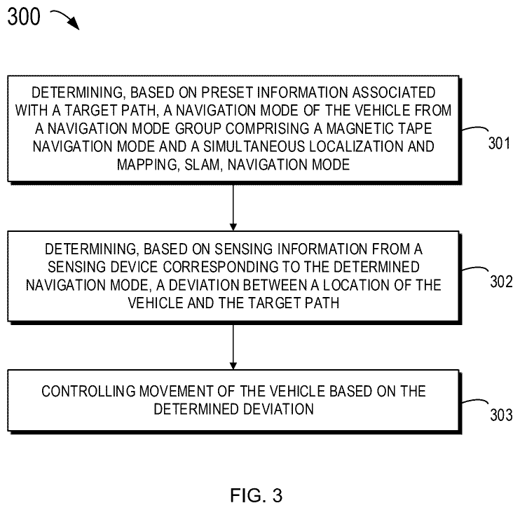

FIG. 3 illustrates a flowchart of a method 300 for controlling the vehicle 100 in accordance with an embodiment of the present disclosure. The method 300 may be implemented by the controller 130 of the vehicle 100 as described above. For discussion, the method 300 will be described below with reference to FIGS. 1 and 2.

At block 301, the controller 130 determines, based on preset information associated with a target path, a navigation mode of the vehicle 100 from a navigation mode group comprising a magnetic navigation mode and a SLAM navigation mode. For example, the target path may be a desired route for a certain task. The preset information for the target path is predetermined before the task is performed, and stored in the vehicle 100, e.g., in the memory of the controller 130, so that the vehicle can automatically perform the certain task based on the preset information for the target path. In an example, the preset information may be input or set by the user in advance. Alternatively, the preset information may be existing information in the memory of the vehicle 100, or may be provided by the remote control center. Since the preset information contains the indication of the navigation mode of the respective area or section, the controller 130 can determine which navigation mode should be adopted by the vehicle 100 in the respective area or section from the preset information.

At block 302, the controller 130 determines, based on sensing information from the sensing device corresponding to the determined navigation mode, a deviation between a location of the vehicle 130 and the target path. For example, in the event of the magnetic navigation, the controller 130 receives the sensing information from the sensing device 110, and in the event of the SLAM navigation, the controller 130 receives the sensing information from the sensing device 120. Through analyzing and calculating the sensing information, the controller 130 can determine the location of the vehicle, thereby determining the deviation between the vehicle 130 and the target path.

At block 303, the controller 130 controls movement of the vehicle 100 based on the determined deviation. As an example, the controller 130 can control the driving assembly 140 to adjust the movement of the vehicle, thereby reducing or eliminating the deviation of the vehicle from the target path.

In this way, the navigation mode of the vehicle 100 can be conveniently determined from the preset information, so that the vehicle 100 can adopts a suitable mode to navigate the vehicle 100, and the navigation mode can be easily changed and set according to the user's requirements. As a result, the vehicle 100 can be integrated with both of the magnetic navigation and the SLAM navigation with a low cost and effort, and thus the setting and change of the route are more flexible and easy while ensuring high positioning accuracy in the areas with high accuracy requirements.

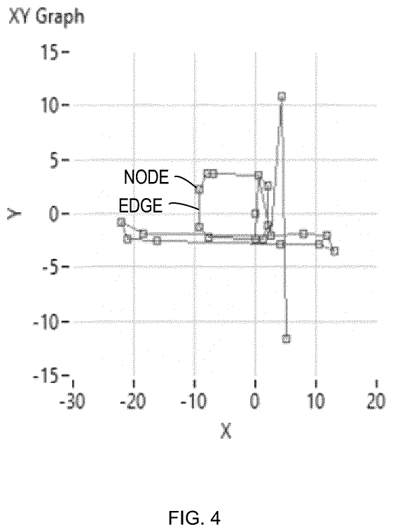

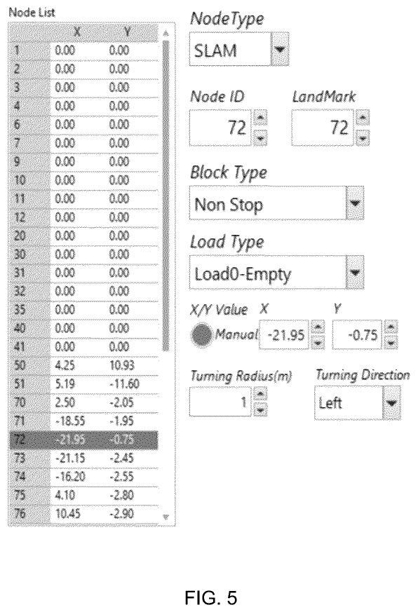

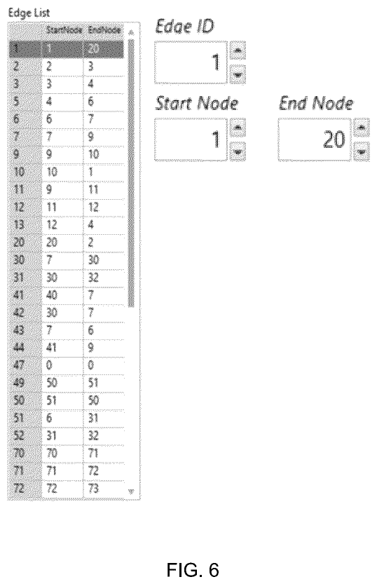

FIGS. 4, 5 and 6 illustrate schematic diagrams of a human-machine interface (HMI) for the target path of the vehicle 100 in accordance with an embodiment of the present disclosure. By way of an example, the HMI may be provided in the vehicle 100 or in a remote control center. By means of the HMI, controlling parameters may be input or provided to the vehicle 100, and state parameters related to the vehicle 100 may be present to an operator or user. As shown in FIG. 4, a target path is presented in a XY graph, and comprises a plurality of nodes and at least one edge between nodes. As an example, the nodes of the target path may be the points (e.g., the points 220 with the tags, or the virtual points 240 in FIG. 1) at which the vehicle 100 carries out certain actions such as start and stop, acceleration and deceleration, pin lift and down, charging, parameter switching, etc. Furthermore, the edge may be the desired travel route between two adjacent nodes, and comprises a line and/or an arc. In FIGS. 5 and 6, the preset information associated with the nodes and the edges in the FIG. 4 are shown, and can be set or changed conveniently. For example, the preset information associated with the nodes comprises, but is not limited to, node list, node type, node ID, X/Y value of the respective node, etc., and the preset information associated with the edges comprises, but is not limited to, edge list, edge ID, start node, end node, etc. The node and edge lists show all the nodes and edges of the target path respectively. The node type indicates the navigation mode which may be one of multiple modes (e.g., the magnetic and SLAM navigation modes), the node ID indicate the number of the respective node, the land mark indicates the tag number, the X/Y value indicates the coordinate of the respective node in the XY graph, the edge ID indicates the number of the respective edge, the start and end nodes indicate the start and end points of the respective edge in the target path. Furthermore, the block type involves whether the vehicle stops at the respective node, the load type involves the load state of the vehicle 100, and the turning radium and direction involve the radius and direction of a curve along which the vehicle 100 travels. It is appreciated that more or less preset information may be provided. Furthermore, the target path comprising the nodes and edges can be predefined and changed according to user requirements and actual tasks, and the target path and the preset information thereof may be present in the form of a map and/or other suitable forms and may be shared by both of the magnetic and SLAM navigations.

In some embodiments, the controller 130 identifies a latest node reached by the vehicle in the plurality of nodes, and determines the navigation mode of the vehicle based on the preset type of the identified latest node. For example, the node type of the node 72 which is highlighted in the node list is selected as SLAM. As the vehicle reaches the node 72, the navigation mode is determined as the SLAM navigation, and the vehicle 100 will enter the SLAM navigation mode and navigate in this mode at least until the next node in the target path. In this way, the vehicle can be conveniently and reliably switched to any of multiple navigation modes during the travel, thereby being advantageously compatible with the multiple navigation modes.

In some embodiments, the controller 130 determines displacement and angle differences between the location of the vehicle 100 and the target path based on the sensing information, and then determines the deviation between the location of the vehicle and the target path based on the displacement and angle differences. As an example, the displacement and angle differences can be easily determined in both of the SLAM and magnetic navigations. Thus, the deviations in different navigation modes can be normalized. As a result, a same control system or loop can be advantageously used in both of the SLAM and magnetic navigation modes, and there is no need to provide two distinct control systems or loops for the two navigation modes. In some embodiments, the controller 130 calculates the deviation by adding a product of the displacement difference and a first constant to a product of the angle difference and a second constant. In this way, the deviations obtained in the magnetic and SLAM navigation modes can be normalized, so that the same control system or loop can effectively adjust the movements of the vehicle based on the normalized deviation.

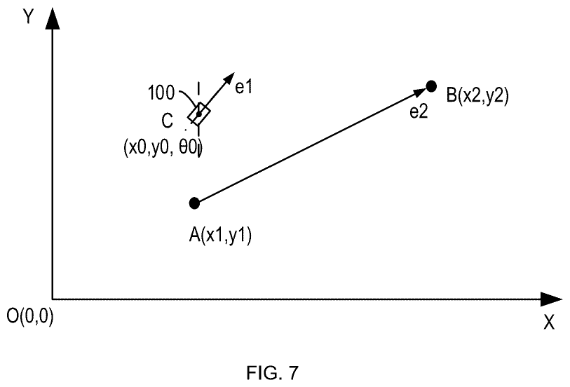

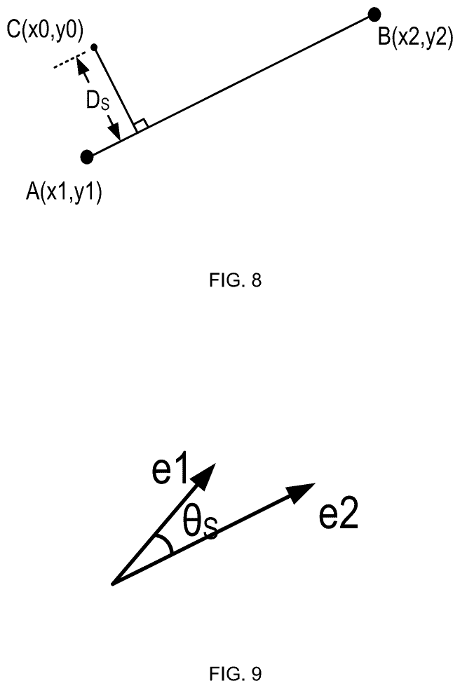

FIG. 7 illustrates a schematic diagram of the coordinate relationship between the vehicle 100 and a section of the target path in accordance to an embodiment of the present disclosure, FIG. 8 illustrates a schematic diagram of the displacement difference Ds between the vehicle 100 and the target path, and FIG. 9 illustrates a schematic diagram of the displacement difference θS between the vehicle 100 and the target path. With reference to FIG. 7 to FIG. 9, the details of determination of the displacement and angle differences in the SLAM navigation mode will be discussed in the following.

As shown in FIG. 7, a node A, a node B and an edge between the nodes A and B belong to a section the target path for the vehicle 100, wherein the node A is the SLAM type. The vehicle 100 passed through the node A and is moving toward the node B. In other words, the node A is the latest node reached by the vehicle 100, and the node B is the next node in the target path. During the movement, the vehicle 100 navigated in the SLAM navigation mode has deviated from the target path.

In the event of the SLAM navigation, the controller 130 can receive first sensing information from the sensing device 120 comprising the at least one of the laser radar and the vision sensor, the first sensing information indicating a position and orientation of the vehicle. Then, the controller 130 can calculate the displacement and angle differences between the location of the vehicle 100 and the target path based on the first sensing information.

For example, the controller 130 of the vehicle 100 determines a pose (x₀, y₀, θ₀) of the vehicle 100 based on the first sensing information of the sensing device 120 (e.g., the laser radar or the vision sensor), so that the coordinate (x₀, y₀) and the orientation angle θ₀ of the vehicle 100 is determined. Furthermore, according to the preset information for the target path, it is known that the node A is located at the coordinate (x₁, y₁) and the node B is located at the coordinate (x₂, y₂). Thereby, based on the coordinate (x₀, y₀) and orientation angle θ₀ of the vehicle and the coordinates (x₁, y₁) and (x₂, y₂) of the nodes A and B, the displacement and angle differences between the location of the vehicle and the target path can be calculated.

In some embodiments, based on the coordinate (x₀, y₀) of the vehicle 100 and the coordinates (x₁, y₁) and (x₂, y₂) of the nodes A and B, the controller 130 can determine whether the vehicle 100 lies on the left side or right side of an edge between the nodes A and B, which indicates different signs of the deviation. That is, the sign of the displacement difference Ds in the event of the vehicle 100 lying on the left side will be opposite to that in the event of the vehicle 100 lying on the right side.

As an example, whether the vehicle 100 lies on the left side or right side of an edge between the nodes A and B may be determined by the following equation:

$$S = ( {x}_{1} - {x}_{0} ) \cdot ( {y}_{2} - {y}_{0} ) - ( {y}_{1} - {y}_{0} ) \cdot ( {x}_{2} - {x}_{0} ) \qquad ( 1 )$$

The result S actually is the area of the three points (x₁, y₁), (x₂, y₂) and (x₀, y₀). If S<0, the vehicle 100 (i.e., the point (x₀, y₀)) lies on the right side of the edge between the nodes A and B, and if S>0, the vehicle 100 lies on the left side, and if S=0, the vehicle 100 lies exactly on the edge. Thus, the controller 130 can determine that the vehicle 100 in FIG. 8 is located on the left side of the edge, and in the event that the left side represent the positive and the right side represent the negative, the sign of the displacement Ds is positive.

As shown in FIG. 8, based on the coordinate (x₀, y₀) of the vehicle 100 and the coordinates (x₁, y₁) and (x₂, y₂) of the nodes A and B, the controller 130 can calculates a magnitude (i.e., an absolute value) of the displacement difference Ds. For example, the magnitude of the displacement difference Ds may be calculated by the following equation:

$$\vert {D}_{S} \vert = \frac{\vert M {x}_{0} + {Ny}_{0} + K \vert}{\sqrt{{M}^{2} + {N}^{2}}} \qquad ( 2 )$$

The coefficients M, N and K are taken from an equation Mx+Ny+K=0 representing a straight line determined by the nodes A (x₁, y₁) and B (x₂, y₂), wherein M=y₂-y₁, N=x₁-x₂ and K=x₂·y₁−x₁·y₂.

As shown in FIG. 9, the controller 130 can calculate the angle difference θ_{S} based on the orientation angle of the vehicle and the coordinates of the nodes A and B. For example, based on the pose (x₀, y₀, θ₀) of the vehicle 100, the orientation of the vehicle can be also represented by a vector e1, and based on the coordinates of the nodes A and B, the edge between the nodes A and B can be also represented by a vector e2. Then, the angle difference θ_{S} between the vehicle 100 and the target path is calculated by the following equations:

$$cos θ = \frac{e 1 \cdot e 2}{\vert e 1 \vert \vert e 2 \vert} or sin θ = \frac{\vert e 1 \times e 2 \vert}{\vert e 1 \vert \vert e 2 \vert} \qquad ( 3 )$$

It is appreciated that the equations (1), (2) and (3) are exemplary only, and other suitable ways or approaches also can be used for determining the displacement and angle differences in the SLAM navigation mode. Furthermore, in some examples, the edge between the nodes A and B may be an arc or other type, instead of a straight line. In the case of the edge being the arc type, the displacement difference may be the distance from the vehicle to the closest point on the arc which can be determined or calculated using geometry knowledge, e.g., based on the coordinates of the nodes A and B, the radius of the arc and the coordinate of the vehicle. Furthermore, in the case of the edge being the arc type, the angle difference may be the angle between the orientation of the vehicle and the tangent at the closest point on the arc, which may be calculated or determined using the geometry knowledge, e.g., based on the coordinates of the nodes A and B, the radius of the arc and the orientation angle of the vehicle.

In some embodiments, the controller 130 can calculate a distance between the vehicle 100 and the next node (e.g., node B) based on the real-time coordinate of the vehicle 100 and the coordinate of the next node (e.g., B (x₂, y₂)). In response to the distance less than a threshold, the controller 130 determines that the vehicle 100 reaches the next node B. For example, the threshold may be set as a lower value, and if the distance between the vehicle 100 and the next node is lower than the threshold, it is considered that the distance is small enough and the vehicle 100 has reached the next node. In this way, the controller 130 can identify the node reached by the vehicle 100, and accurately switch the navigation mode according to the type of the reached node.

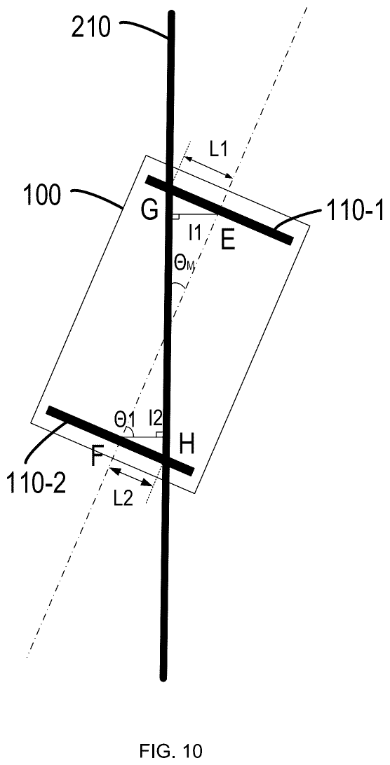

FIG. 10 illustrates a schematic diagram of the position relationship between the vehicle 100 and a section of the target path in the magnetic navigation mode in accordance to an embodiment of the present disclosure. With reference to FIG. 10, the details of determination of the displacement and angle differences in the magnetic navigation mode will be discussed in the following.

If the navigation mode of the vehicle 100 is the magnetic navigation mode, the controller 130 receives second sensing information from the sensing device 110 (e.g., the plurality of magnetic stripe sensors), and calculates, based on the second sensing information, the displacement and angle differences between the location of the vehicle 100 and the target path. The second sensing information indicates positions of the plurality of magnetic stripe sensors relative to a magnetic tape. For example, the plurality of magnetic stripe sensors comprise a first magnetic stripe sensor 110-1 arranged at the front of the vehicle 100 and a second magnetic stripe sensor 110-2 arranged at the back of the vehicle 100. The first magnetic stripe sensor 110-1 detects the first offset L1 from the magnetic tape 210, and the second magnetic stripe sensor 110-2 detects the second offset L2 from the magnetic tape 210. Assuming that the distance between the center positions E and F of the first and second magnetic strip sensors is known and based on the knowledge of similar triangles, the vertical distance 11 between the center position of the first magnetic strip sensor 110-1 and the magnetic tape 210, the vertical distance 12 between the center position F of the second magnetic tape sensor 110-2 and the magnetic tape 210, and the angle θ1 can be calculated. Thereby, the displacement difference Dy between the center position of the vehicle 100 and the target path can be determined as (l1+l2)/2, and the angle difference OM between the center position of the vehicle 100 and the target path can be determined as (90°−θ₁). It is appreciated that the above implementation is only an example, and other suitable ways or approaches also can be used for determining the displacement and angle differences in the magnetic navigation mode.

In some embodiments, the controller 130 of the vehicle 100 receives a detection signal from a RFID sensor, and in response to the detection signal identifying a next node in the target path, the controller 130 determines that the vehicle 100 reaches the next node. Specifically, the vehicle 100 is provided with the RFID sensor for detecting the RFID tags mounted on the nodes of the magnetic tape 210. When the RFID sensor of the vehicle 100 reads the tag of the node B, it means that the vehicle has arrived at the node B. In this way, the controller 130 can identify the node reached by the vehicle 100, and accurately switch the navigation mode according to the type of the reached node.

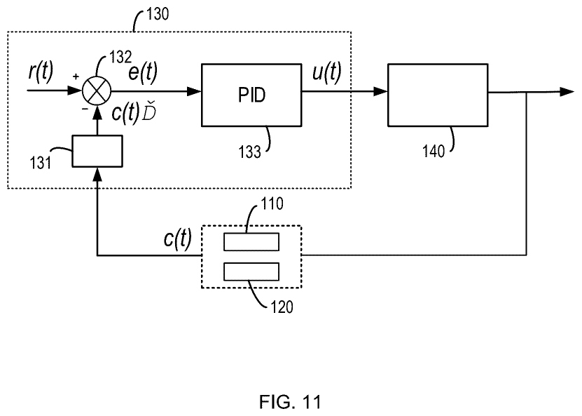

FIG. 11 illustrates a schematic block diagram of the sensing devices 110 and 120, the controller 130 and the driving assembly 140 in accordance with an embodiment of the present disclosure. As shown in FIG. 11, the controller 130 determines a difference e(t) between the determined deviation c(t)′ and a reference deviation r(t), and controls the movement of the vehicle 100 based on the determined difference e(t). As an example, the controller 130 may comprise a calculating unit 131, a difference unit 132 and a proportion integration differentiation (PID) unit 133. The calculating unit 131 determines the deviation c (t)′ based on the sensing information c(t) from the sensing devices 110 and 120. The determined deviation c(t)′ and a reference deviation r(t) are input to the difference unit 132. Then, the difference e(t) is generated and output from the difference unit 132 to the PID unit 133. The PID unit 133 adjusts the determined difference e(t) and provides an output u(t) to the driving assembly 140. After the output u(t) is sent to the driving assembly 140, the motor of the driving assembly 140 adjusts the movement of the vehicle 100 (e.g., the speed of the left and right wheels) accordingly so as to reduce the deviation of the vehicle 100 along the target path. In an embodiment, the reference deviation r(t) is defined as zero to minimize the deviation between the location of the vehicle 100 and the target path. In this way, a closed control loop is formed and a PID control is provided, so that the deviation can be reduced or eliminated as much as possible.

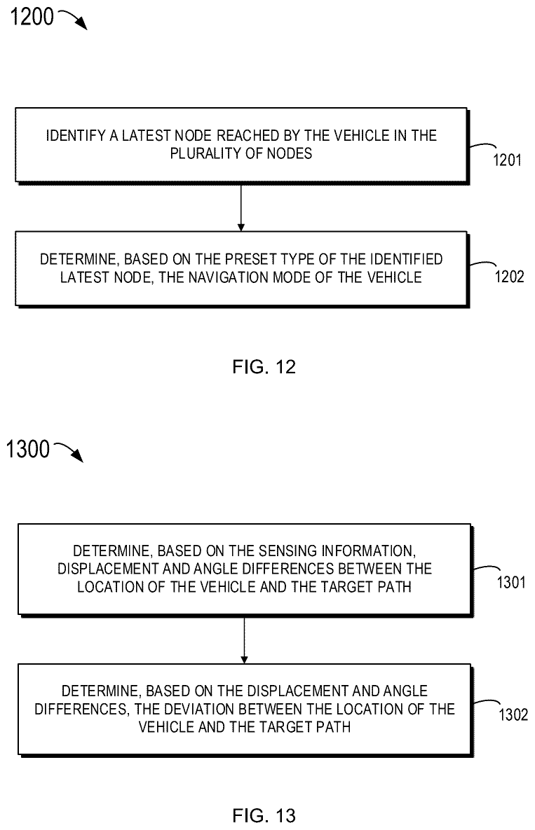

FIG. 12 illustrates a flowchart of procedure 1200 of determining the navigation mode of the vehicle 100 in accordance with an embodiment of the present disclosure. The procedure 1200 may be implemented by the controller 130 as described above.

At block 1201, the controller 130 identifies a latest node reached by the vehicle 100 in the plurality of nodes.

At block 1202, the controller 130 determines, based on the preset type of the identified latest node, the navigation mode of the vehicle 100.

FIG. 13 illustrates a flowchart of procedure 1300 of determining the deviation between the location of the vehicle 100 and the target path in accordance with an embodiment of the present disclosure. The procedure 1300 may be implemented by the controller 130 as described above.

At block 1301, the controller 130 determines, based on the sensing information, displacement and angle differences between the location of the vehicle 100 and the target path.

At block 1302, the controller 130 determines, based on the displacement and angle differences, the deviation between the location of the vehicle 100 and the target path. In some embodiments, the controller 130 calculates the deviation by adding a product of the displacement difference and a first constant to a product of the angle difference and a second constant.

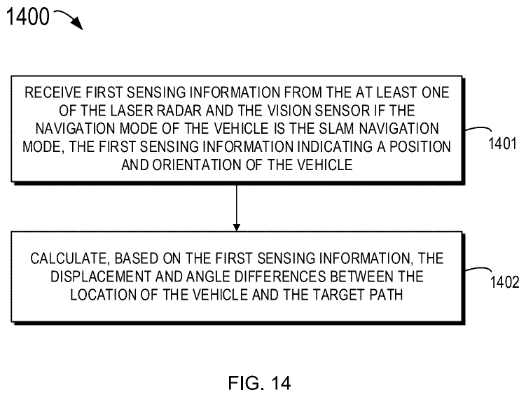

FIG. 14 illustrates a flowchart of procedure 1400 of determining the displacement and angle differences in the SLAM navigation mode in accordance with an embodiment of the present disclosure. The procedure 1400 may be implemented by the controller 130 as described above.

At block 1401, if the navigation mode of the vehicle 100 is the SLAM navigation mode, the controller 130 receives the first sensing information from the at least one of the laser radar and the vision sensor, the first sensing information indicating a position and orientation of the vehicle.

At block 1402, the controller 130 calculates, based on the first sensing information, the displacement and angle differences between the location of the vehicle and the target path.

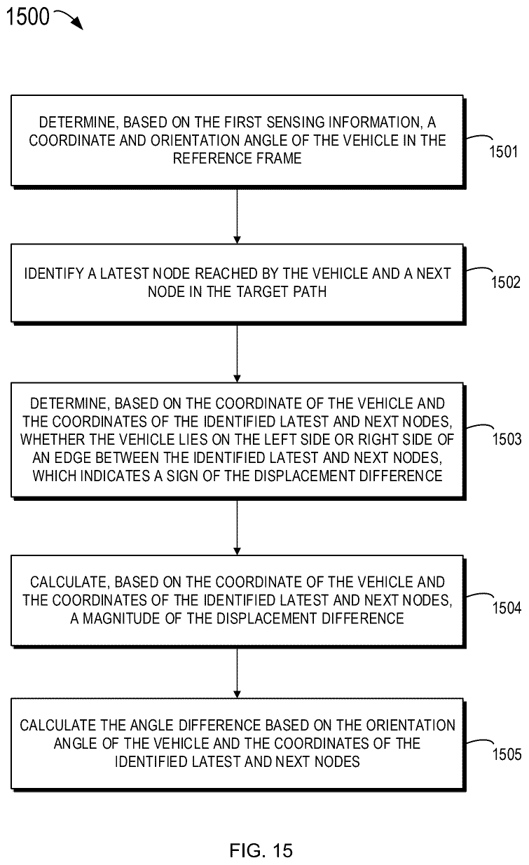

FIG. 15 illustrates a flowchart of procedure 1500 of calculating the displacement and angle differences based on the first sensing information in accordance with an embodiment of the present disclosure. The procedure 1500 may be implemented by the controller 130 as described above.

At block 1501, the controller 130 determines, based on the first sensing information, a coordinate and orientation angle of the vehicle 130 in the reference frame.

At block 1502, the controller 130 identifies a latest node reached by the vehicle 100 and a next node in the target path.

At block 1503, the controller 130 determines, based on the coordinate of the vehicle and the coordinates of the identified latest and next nodes, whether the vehicle 100 lies on the left side or right side of an edge between the identified latest and next nodes, which indicates a sign of the displacement difference.

At block 1504, the controller 130 calculates, based on the coordinate of the vehicle 100 and the coordinates of the identified latest and next nodes, a magnitude of the displacement difference.

At block 1505, the controller 130 calculates the angle difference based on the orientation angle of the vehicle and the coordinates of the identified latest and next nodes.

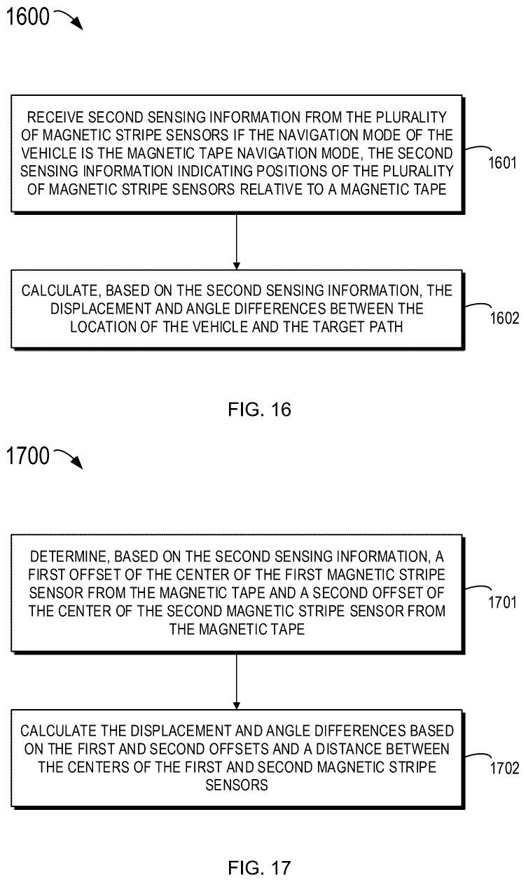

FIG. 16 illustrates a flowchart of procedure 1600 of determining the displacement and angle differences in the magnetic navigation in accordance with an embodiment of the present disclosure. The procedure 1600 may be implemented by the controller 130 as described above.

At block 1601, if the navigation mode of the vehicle 100 is the magnetic navigation mode, the controller 130 receives second sensing information from the plurality of magnetic stripe sensors, the second sensing information indicating positions of the plurality of magnetic stripe sensors relative to a magnetic tape.

At block 1602, the controller 130 calculates, based on the second sensing information, the displacement and angle differences between the location of the vehicle 100 and the target path.

FIG. 17 illustrates a flowchart of procedure 1700 of calculating the displacement and angle differences based on the second sensing information in accordance with an embodiment of the present disclosure. The procedure 1700 may be implemented by the controller 130 as described above.

At block 1701, the controller 130 determines, based on the second sensing information, a first offset of a center of a first magnetic stripe sensor 110-1 from the magnetic tape and a second offset of a center of a second magnetic stripe sensor 110-2 from the magnetic tape, the first magnetic stripe sensor 110-1 being arranged at the front of the vehicle 100, the second magnetic stripe sensor 110-2 being arranged at the back of the vehicle 100.

At block 1702, the controller 130 calculates the displacement and angle differences based on the first and second offsets and a distance between the centers of the first and second magnetic stripe sensors 110-1 and 110-2.

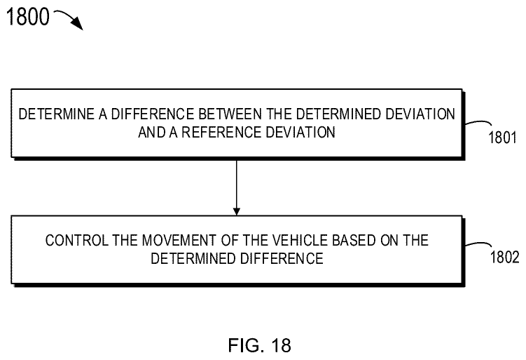

FIG. 18 illustrates a flowchart of procedure 1800 of controlling the movement of the vehicle based on the determined deviation in accordance with an embodiment of the present disclosure. The procedure 1800 may be implemented by the controller 130 as described above.

At block 1801, the controller 130 determines a difference between the determined deviation and a reference deviation.

At block 1802, the controller 130 controls the movement of the vehicle 100 based on the determined difference.

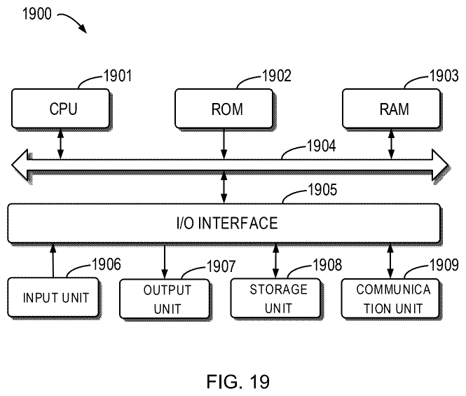

According to other aspects of the present disclosure, an electronic device that can implement embodiments of the present disclosure as mentioned above is provided. FIG. 19 shows a schematic block diagram of an example device 1900 adapted to implement embodiments of the present disclosure. For example, the controller 130 may be implemented by the device 1900. As shown therein, the device 1900 comprises a central processing unit (CPU) 1901 that may perform various appropriate actions and processing based on computer program instructions stored in a read-only memory (ROM) 1902 or computer program instructions loaded from a storage section 1908 to a random access memory (RAM) 1903. In the RAM 1903, various programs and data needed for operations of the device 1900 are further stored. The CPU 1901, ROM 1902 and RAM 1903 are connected to each other via a bus 1904. An input/output (I/O) interface 1905 is also connected to the bus 1904.

The following components in the device 1900 are connected to the I/O interface 1905: an input unit 1906, such as a keyboard, a mouse and the like; an output unit 1907, such as various kinds of displays and a loudspeaker, etc.; a memory unit 1908, such as a magnetic disk, an optical disk, etc.; a communication unit 1909, such as a network card, a modem, a wireless communication transceiver, etc. The communication unit 1909 allows the device 1900 to exchange information/data with other devices through a computer network such as the Internet and/or various kinds of telecommunications networks.

Various processes and processing described above, e.g., the method 300 may be executed by the processing unit 1901. For example, in some embodiments, the method 300 may be implemented as a computer software program that is tangibly embodied on a machine readable medium, e.g., the storage unit 1908. In some embodiments, part or all of the computer programs may be loaded and/or mounted onto the device 1900 via ROM 1902 and/or communication unit 1909. When the computer program is loaded to the RAM 1903 and executed by the CPU 1901, one or more acts of the method 300 as described above may be executed.

According to another aspect of the present disclosure, a computer readable storage medium (or media) having computer readable program instructions thereon for performing aspects of the present disclosure is provided.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages. The computer readable program instructions may execute entirely on the controller 130, partly on the controller 130, as a stand-alone software package, partly on the controller 130 and partly on a remote computer. In the scenario involving the remote computer, the remote computer may be connected to the user's computer through any type of network, including a local area network (LAN) or a wide area network (WAN), or the connection may be made to an external computer (for example, through the Internet using an Internet Service Provider). In some embodiments, the electronic circuitry can be customized by utilizing state information of the computer readable program instructions, for example, programmable logic circuitry, field-programmable gate arrays (FPGA), or programmable logic arrays (PLA). The electronic circuitry may execute the computer readable program instructions, in order to perform aspects of the present disclosure.

Aspects of the present disclosure are described herein with reference to flowchart illustrations and/or block diagrams of methods, device (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can enable a computer, a programmable data processing apparatus, and/or other devices to function in a particular manner, such that the computer readable storage medium having instructions stored therein comprises an article of manufacture, which includes instructions implementing aspects of the function/act specified in block or blocks of the flowchart and/or block diagram.

The computer readable program instructions may also be loaded onto a computer, other programmable data processing apparatuses, or other device to cause a series of operational steps to be performed on the computer, other programmable data processing apparatuses or other devices to produce a computer implemented process, such that the instructions which execute on the computer, other programmable data processing apparatuses, or other devices implement the functions/acts specified in block or blocks of the flowchart and/or block diagram.

It should be appreciated that the above detailed embodiments of the present disclosure are only to exemplify or explain principles of the present disclosure and not to limit the present disclosure. Therefore, any modifications, equivalent alternatives and improvement, etc. without departing from the spirit and scope of the present disclosure shall be comprised in the scope of protection of the present disclosure. Meanwhile, appended claims of the present disclosure aim to cover all the variations and modifications falling under the scope and boundary of the claims or equivalents of the scope and boundary.

1. A method for controlling a vehicle, comprising:
determining, based on preset information associated with a target path, a navigation mode of the vehicle from a navigation mode group comprising a magnetic navigation mode and a simultaneous localization and mapping, SLAM, navigation mode;
determining, based on sensing information from a sensing device corresponding to the determined navigation mode, a deviation between a location of the vehicle and the target path; and
controlling movement of the vehicle based on the determined deviation.

2. The method of claim 1, wherein the target path comprises a plurality of nodes and at least one edge between nodes.

3. The method of claim 2, wherein the preset information comprises a preset type of the respective node, and
determining, based on the preset information associated with the target path, the navigation mode of the vehicle from the navigation mode group comprises:
identifying a latest node reached by the vehicle in the plurality of nodes; and
determining, based on the preset type of the identified latest node, the navigation mode of the vehicle.

4. The method of claim 2, wherein determining, based on the sensing information from the sensing device corresponding to the determined navigation mode, the deviation between the location of the vehicle and the target path comprises:
determining, based on the sensing information, displacement and angle differences between the location of the vehicle and the target path; and
determining, based on the displacement and angle differences, the deviation between the location of the vehicle and the target path.

5. The method of claim 4, wherein determining, based on the displacement and angle differences, the deviation between the location of the vehicle and the target path comprises:
calculating the deviation by adding a product of the displacement difference and a first constant to a product of the angle difference and a second constant.

6. The method of claim 4, wherein the sensing device corresponding to the SLAM navigation comprises at least one of a laser radar and a vision sensor, and
determining, based on the sensing information, the displacement and angle differences between the location of the vehicle and the target path comprises:
if the navigation mode of the vehicle is the SLAM navigation mode, receiving first sensing information from the at least one of the laser radar and the vision sensor, the first sensing information indicating a position and orientation of the vehicle; and
calculating, based on the first sensing information, the displacement and angle differences between the location of the vehicle and the target path.

7. The method of claim 6, wherein the preset information comprises a coordinate of the respective node in a reference frame, and
calculating, based on the first sensing information, the displacement and angle differences between the location of the vehicle and the target path comprises:
determining, based on the first sensing information, a coordinate and orientation angle of the vehicle in the reference frame;
identifying a latest node reached by the vehicle and a next node in the target path;
calculating, based on the coordinate and orientation angle of the vehicle and the coordinates of the identified latest and next nodes, the displacement and angle differences between the location of the vehicle and the target path.

8. The method of claim 7, wherein calculating, based on the coordinate and orientation angle of the vehicle and the coordinates of the identified latest and next nodes, the displacement and angle differences between the location of the vehicle and the target path comprises:
determining, based on the coordinate of the vehicle and the coordinates of the identified latest and next nodes, whether the vehicle lies on the left side or right side of an edge between the identified latest and next nodes, which indicates a sign of the displacement difference;
calculating, based on the coordinate of the vehicle and the coordinates of the identified latest and next nodes, a magnitude of the displacement difference; and
calculating the angle difference based on the orientation angle of the vehicle and the coordinates of the identified latest and next nodes.

9. The method of claim 4, wherein the sensing device corresponding to the magnetic navigation mode comprises a plurality of magnetic stripe sensors, and
determining, based on the sensing information, the displacement and angle differences between the location of the vehicle and the target path comprises:
if the navigation mode of the vehicle is the magnetic navigation mode, receiving second sensing information from the plurality of magnetic stripe sensors, the second sensing information indicating positions of the plurality of magnetic stripe sensors relative to a magnetic tape; and
calculating, based on the second sensing information, the displacement and angle differences between the location of the vehicle and the target path.

10. The method of claim 9, wherein the plurality of magnetic stripe sensors comprise a first magnetic stripe sensor arranged at the front of the vehicle and a second magnetic stripe sensor arranged at the back of the vehicle, and
calculating, based on the second sensing information, the displacement and angle differences between the location of the vehicle and the target path comprises:
determining, based on the second sensing information, a first offset of the center of the first magnetic stripe sensor from the magnetic tape and a second offset of the center of the second magnetic stripe sensor from the magnetic tape; and
calculating the displacement and angle differences based on the first and second offsets and a distance between the centers of the first and second magnetic stripe sensors.

11. The method of claim 1, wherein controlling the movement of the vehicle based on the determined deviation comprises:
determining a difference between the determined deviation and a reference deviation; and
controlling the movement of the vehicle based on the determined difference.

12. The method of claim 2, wherein the preset information comprises a coordinate of the respective node in a reference frame,
the method further comprising:
if the navigation mode of the vehicle is the SLAM navigation mode, determining, based on the sensing information, a coordinate of the vehicle in the reference frame;
calculating, based on the coordinates of the vehicle and the next node in the reference frame, a distance between the vehicle and the next node; and
in response to the distance less than a threshold, determining that the vehicle reaches the next node.

13. The method of claim 2, further comprising:
if the navigation mode of the vehicle is the magnetic navigation mode, receiving a detection signal from a RFID sensor; and
in response to the detection signal identifying a next node in the target path, determining that the vehicle reaches the next node.

14. A controller for controlling a vehicle, comprises:
at least one processing unit; and
at least one memory coupled to the at least one processing unit and storing instructions executable by the at least one processing unit, the instructions, when executed by the at least one processing unit, causing the device to perform the method according to claim 1.

15. A computer readable storage medium having computer readable program instructions stored thereon which, when executed by a processing unit, cause the processing unit to perform the method according to claim 1.

16. A vehicle, comprising:
sensing devices; and
the controller according to claim 14.

17. The vehicle of claim 16, wherein the sensing devices comprises a plurality of magnetic stripe sensors and at least one of a laser radar and a vision sensor.
